(19) United States
(12) Patent Application Publication
(10) Pub. No.: US 2020/0219186 A1
(43) Pub. Date: Jul. 9, 2020

(54) Equity Lease/Swap

(71) Applicant: Amin Zameni, Mission Viejo, CA (US)

(72) Inventor: Amin Zameni, Mission Viejo, CA (US)

(21) Appl. No.: 16/737,510

(22) Filed: Jan. 8, 2020

Related U.S. Application Data
(60) Provisional application No. 62/790,213, filed on Jan. 9, 2019.

(51) Int. Cl. G06Q 40/02; G06Q 40/06; G06Q 50/16

(52) U.S. Cl. CPC G06Q 40/025; G06Q 50/16; G06Q 40/06

(57) ABSTRACT

A method, system and financial product for accessing untapped equity and paying income to the homeowner.

This application claims priority to U.S. Provisional Patent Application No. 62/790,213, entitled “EQUITY LEASE/SWAP,” filed Jan. 9, 2019, the entirety of which is incorporated herein by reference.

### FIELD

The present disclosure relates to accessing equity in a home. In particular, the present disclosure relates to access untapped equity and in addition, pay income to the homeowner.

### BACKGROUND

To access the equity in a home, owners currently borrow against that equity. Present lending laws and real estate loan structures have made it extremely difficult for most property owners to qualify for and borrow against the equity in their properties.

Previous products such as a HELOC (Home Equity Line Of Credit), regular refinances, and lines of credit all cash out equity for the property owner at a cost and monthly payments. The reverse mortgage gives the option to the property owner not to make any monthly payments in exchange for depleting the property's equity and is subject to age restrictions of 62 years or older. Therefore, the reverse mortgage is not available to the general public. None of these existing products provides for a permanent relief of the monthly payments associated with such loans and do not provide a monthly income to the property owner.

Offers of products like the reverse mortgage have been known to take advantage of desperate people as a natural customer base. While a reverse mortgage may access equity, it is still a loan that depletes equity. Typically, there is still an income requirement as well as owner-occupancy requirement, and the homeowner must maintain insurance, property taxes, HOA fees, and maintenance out of their own pocket. Additionally, property owners who do wish to tap into equity must make monthly payments on it, often at high interest rates. In all scenarios, qualifying may be difficult, equity is depleted, and property owners have an added burden of making monthly payments for the equity used. This makes tapping into one's equity unappealing unless circumstances are dire.

Thus, there is a need for a financial product that would allow property owners to access equity without any monthly payment obligation, and receive an income as long as they are part of the program.

### SUMMARY

Disclosed is a method and financial product (collectively herein, the “method”) to lease/swap untapped equity in a home. In exchange, a dividend/income is paid back to the equity trader/property owner. The disclosed method also foregoes the responsibility of the property owner to make payments on an equity loan, providing monthly income or cash dividends, as well. The method allows a mortgage or banking entity to give a loan to a borrower and instead of collecting a payment to repay the entity, the borrower is paid a monthly cash income/dividend. Not only can property owners receive monthly revenue, if the need exists, property owners may also receive a portion of their equity to use for any purpose they choose in exchange for a lower monthly dividend.

The method is based on the amount of equity a property owner has in their property. The term “homeowner” may be used for simplicity to distinguish the individual or entity from other property owners, but the “homeowner's property need not be the owner's residence, and can be any property owned, including for example, commercial property or second homes. Depending on the type of property, the parameters of the model may vary.

The entire process may not require good credit or qualifying income. Property owners who have enough equity in their properties could qualify for the program. This method and financial product could free up trillions of dollars currently locked away in properties and instead put the money to work, helping not only the property owners and businesses involved, but the broader economy. The disclosed method may give those with poor credit, on fixed incomes, unemployed, or difficult-to-document income access to trapped equity. Those facing divorces, health emergencies, death of a loved one, even those starting a business may be able to get access to the money they need as income—not a loan—while protecting their equity. The disclosed method also may provide an unprecedented level of security including insurance that guarantees the payment. Property owners may be able to access untapped equity with lower-than-typical costs and less stress.

### DESCRIPTION OF DRAWINGS

The detailed description refers to the accompanying figures, which depict illustrative embodiments.

FIG. 1 depicts steps of a method according to an illustrative embodiment of the disclosed methods.

FIGS. 2A, 2B are simplified diagrams illustrating interaction of a homeowner, strategic partners, funding sources and a coordinator through a network to carry out embodiments of the disclosed method of equity leasing or swapping and related system.

FIG. 3 is a block diagram of an exemplary hardware environment for the equity lease/swap platform, according to an illustrative embodiment of the disclosed system.

FIG. 4 depicts illustrative webpages according to embodiments of the disclosed method and system.

FIG. 5 depicts a logic flow chart according to an illustrative embodiment.

### DETAILED DESCRIPTION OF EMBODIMENTS

The figures and descriptions provided herein may have been simplified to illustrate aspects that are relevant for an understanding of the described devices, systems, and methods, described herein while eliminating, for the purpose of clarity, other aspects that may be found in typical devices, systems, and methods. Those of ordinary skill may recognize that other elements or operations may be desirable or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that could be implemented by those of ordinary skill in the art.

In the disclosed method, real estate equities or cash are invested to secure an income stream. An entity pays a property equity dividend that does not deplete the property owner's equity in the property. For simplicity, the entity will be referred to as the “coordinator.” However, it will be understood that other entities or individuals may be providing the cash that the homeowner will receive, such as a bank or other lending or investment firm. Additionally, the coordinator may be a single organization or person or a group of entities and/or persons acting in coordination to carry out the method or offer the lease/swap financial product. The coordinator can be any form of legal entity, for example, an LLC or corporation, or it can be an individual or non-formal entity.

In essence, the equity in properties is “leased” or “swapped” by arranging a loan and using the equity property owner's collateral for the loan. The coordinator makes the monthly payments and also provides the property owner with income. No qualification is needed other than the property owner having sufficient equity in the real estate.

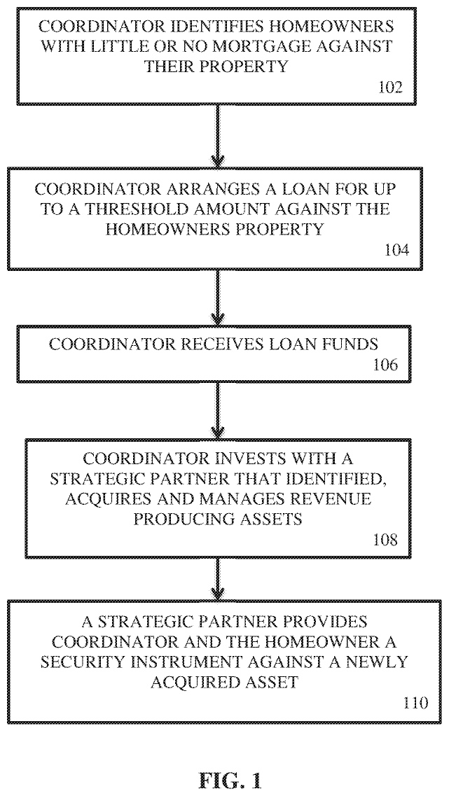

FIG. 1 depicts steps of a method according to an illustrative embodiment of the equity swap or lease method.

In Step 102, the coordinator identifies property owners with free and clear properties. Property owners may have a small mortgage, at which time the coordinator may elect to pay it off as part of its services; in this case, the payment of the income/dividend to the property owner would be adjusted accordingly, to compensate for the amount owed on the property.

In Step 104, the property owner pledges a portion of its equity to the coordinator as a lease/swap of equity. In exchange, the coordinator will arrange a loan and use the property owner's equity as security against that loan.

In Step 106, once the loan is arranged, the net proceeds are assigned to the coordinator. The coordinator is the guarantor for the mortgage payments.

In Step 108, the coordinator receives the proceeds to invest via a strategic partner who will locate a suitable revenue-producing property or other asset in which to invest. The revenue-producing property will deliver the required return to pay the mortgage and the property owner's dividend/income. At this point, there is nothing for the property owner to do except wait for the property equity dividend payments to start. It is noted that the property owner may be referred to herein as the “member” on occasion because the system may be set up to require membership in an organization that alone or in coordination with other entities carries out the method or offers the financial product.

In Step 110, once the revenue-producing property or other asset is identified, a security instrument is recorded with the property owner and the coordinator as co-beneficiaries, thus protecting the property owner's equity note in the newly acquired investment. In essence, the property owner's equity is cashed out and swapped/leased into an alternate property/asset in order to create revenue back to the property owner. The equity provider is responsible to make the payment on such loan and pays to the property owner a cash dividend, resulting in revenue for the property owner. This represents a model wherein a loan is obtained against equity, and instead of the property owner making regular monthly payments for the loan, they will receive a monthly income instead with full security in place.

The major difference between this solution and prior efforts is that with this solution, the property owner may gain a steady source of income without losing any equity. Previous attempts to utilize equity have simply depleted it, while this model allows for a win-win between consumer and investor. Credit score and proof of employment have also hindered efforts to finance equity, neither of which is needed in this model. Rather than the property owner taking the money from the new mortgage, the coordinator leases/swaps the equity and invests and guarantees the return of all leased equity while also making the monthly payments of the new mortgage.

Charts are provided below that compare illustrative embodiments of the lease/swap model with reverse mortgages, Home Equity Line of Credit (HELOC), Home Equity Loans and Refinancing. The comparisons are of illustrative embodiments. Therefore, it is noted that some of the aspects of reverse mortgages, HELOCs, home equity loans and refinancing may still be present in other embodiments of the disclosed method.

| Lease/Swap Model | Reverse Mortgage |
|---|---|
| Loan out the equity built up over | Use up the equity built up over |
| years | the years |
| Get a stream of income based on | Get a stream of income based on |
| the equity available | the equity available and other |
| | requirements |
| Loan repaid by the coordinator | Loan repaid by the homeowner |
| No age restriction | Must be 62 years or older to |
| | qualify |
| Must maintain the home and keep | Must maintain the home and keep |
| property taxes current | property taxes current |
| Can be used on rental property | Must live in the home to qualify |
| Puts a mortgage on the home that | Puts a mortgage on the home that |
| the coordinator is obligated to | the homeowner is obligated to |
| pay | pay when the home is no longer |
| | their primary residence. |
| Must own the property outright or | Must own the property outright |
| have a low mortgage balance | or have a low mortgage balance |
| | that can be paid off with pro- |
| | ceeds from the reverse mortgage. |
| The payment to the homeowner is | The amount of money the home- |
| based on 50% of the equity in the | owner can receive varies and |
| home, or other designated amount. | is dependent on several out- |
| | side factors. |
| Homeowner can cancel the arrange- | Homeowner has only three days |
| ment at any time. A notice period, | after closing to cancel the |
| for example 60 days, may be | agreement. |
| required. | |
| Homeowner gets monthly dividends | Can only get a lump sum dis- |
| but can request a portion of the | bursement if the mortgage has |
| equity as a lump sum payment at | a fixed rate. Adjustable rate |
| any time. The monthly payments | mortgages have various payment |
| from the coordinator will be | options, but a lump sum is |
| adjusted down to cover the lump | not available. |
| sum disbursement. | |
| Costs may include an annual | Fees include origination fee, |
| membership fee ($300 for example) | closing costs, possible mort- |
| and/or an origination fee (1% | gage insurance premium and |
| for example). Cost for mortgage | servicing fees over the life |
| insurance and servicing fees | of the loan. Note that these |
| may paid by the coordinator. | costs are typically, at min- |
| | imum, 1.8% higher than what |
| | may be provided by the |
| | Lease/Swap model coordinator. |
| Proceeds from the loan are invested | Federally insured reverse |
| by the coordinator or its strategic | mortgage funds can be used |
| partner to acquire revenue generating | for any purpose. |
| assets, including commercial pro- | |
| perty, residential rental property, | |
| notes and bonds. The income from | |
| these assets pays a monthly dividend | |
| to the owner that can be used for | |
| any purpose. | |
| Homeowner keeps title to the home | Homeowner keeps title to the |
| | home |
| The loan, principle and interest, are | Homeowner owes more over time |
| paid by the coordinator. Homeowner | as interest is added to the |
| does not have the obligation to pay, | loan balance each month. |
| plus the payment may be insured | |
| against default. | |
| Interest on the loan is paid by the | Interest on the loan is not |
| coordinator so it is not tax deduct- | tax deductible until the loan |
| ible to the homeowner. | is paid back, either partial- |
| | ly or fully. |
| The income stream provided to the | Most reverse mortgages have |
| homeowner can be based on a fixed | variable interest rates caus- |
| rate or adjustable rate. | ing the income stream to vary. |
| In the coordinator transaction, the | A reverse mortgage will use |
| equity is not reduced. When the | up the equity in the home and |
| homeowner cancels the arrangement, | leave fewer assets to heirs. |
| the coordinator may repay the loan | Frequently the heirs have to |
| closing costs. The coordinator then | sell the home to pay off the |
| pays off the mortgage to their home | reverse mortgage and they |
| and the home is once again free | only receive the balance of |
| and clear. | the equity after the mortgage |
| | is paid. |

### Home Equity Line of Credit

| | Home Equity Line of Credit |
|---|---|
| Lease/Swap Model | (HELOC) |
| The member leases his equity to | A HELOC is a loan against the |
| the coordinator. He is not taking | equity in a home. It has a |
| out a loan. | variable interest rate that |
| | fluctuates over the life of |
| | the loan. |
| The owner receives monthly divi- | The owner can withdraw money |
| dends. | when needed. |
| The member's monthly income | The line of credit has a |
| stream is based on a percentage | fixed maximum amount you |
| of the equity in the property, | can withdraw, set by the |
| for example, 50%, or other | lender. |
| designated amount. | |
| The member does not make pay- | The HELOC revolves, as pay- |
| ments. | ments are made the principle |
| | becomes available again. |
| The equity is returned to the | Must be paid off when the |
| member when they exit the | house is sold. |
| program. | |

### Home Equity Loan

| Lease/Swap Model | Home Equity Loan |
|---|---|
| Homeowners receive a monthly | Borrower receives a single lump |
| payment. | payment, with monthly payments |
| | due until the note is paid off. |
| Homeowners lease their equity | The loan is secured by the |
| (secured by a free and clear | equity in the home and trust |
| property or a security instru- | deed. |
| ment) by taking out a mortgage | |
| with the payments made by the | |
| coordinator. | |
| The homeowner receives payments | Loan is for a fixed length of |
| at either fixed or adjustable | time and interest rate. |
| interest rates. There is no | |
| time constraint. | |
| The equity is returned to the | Must be paid off when the house |
| homeowner when they exit the | is sold. |
| program. | |

### Refinance

| Lease/Swap Model | Refinance |
|---|---|
| The homeowner has a mortgage | A new loan against the property used to |
| against a percentage, such | shorten or lengthen the loan term, get a |
| as 50% for example, of his | more favorable interest rate, consolidate |
| equity in the property, | multiple loans on the property or to |
| secured by a free and clear | extract money. |
| property or other security. | |
| The homeowner receives a | The borrower makes principle and |
| monthly income stream. | interest payments. |

In an illustrative embodiment, there are four phases: Phase 1 of the financing encumbers the properties up to a threshold loan to value ratio (LTV), for example 50%. In phase 2 the same loan is made up to a higher LTV, for example in the range of 70-75% LTV. In phase 3 the financing encumbers the properties up to a threshold loan to value ratio (LTV), for example up to 80%. Phase 4 brings the LTV to 100% or more based on the availability of funds and investor's appetite for risk as the coordinator deems. The desired LTV for each phase can be selected based on various considerations, including risk, property value, etc.

Revenue-producing property or other assets may include other forms that can be securitized and/or are securitized already to guarantee the repayment to the property owner. This can include, for example, treasury notes, commercial properties, multi-family properties, and so forth and can be secured against cash reserves. These investments can also be cross-collateralized with other assets to achieve the same objective.

The model may include a membership offering. Property owners can obtain membership by paying a fee and thus having the financial product available to them. The financial product can also be licensed to other coordinators or entities that would like to offer the method to its own members or users.

Various insurance products can also be offered by the coordinator or other related entity to both the lender and the property owner to lower costs, including but not limited to fire insurance, life and disability insurance, health insurance, long-term care insurance, and so forth. The premiums can be paid for by the monthly dividends/income the property owner receives.

Funding of mortgages can be from any source. Illustrated sources include, for example, institutional investors, hedge funds, retirement funds, insurance funds, banks, and so forth.

Embodiments of the disclosed method may be implemented via a software platform. Blockchain technology can be incorporated to provide added security to property owners and others executing actions involved in the method. The platform may allow for standardization of the model, particularly across licensees.

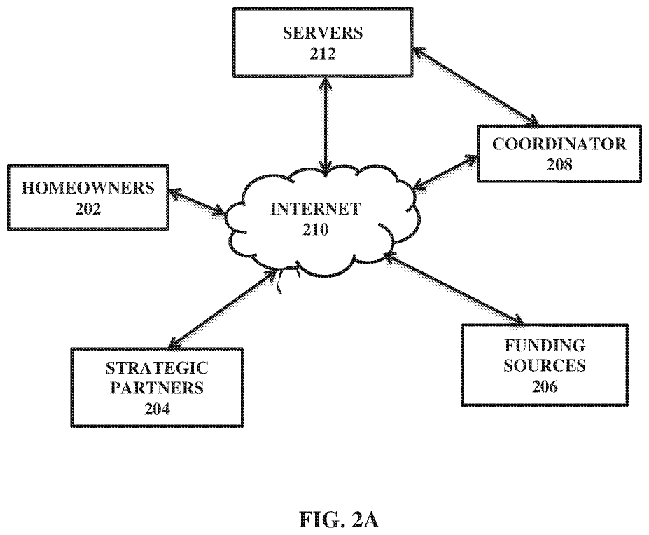

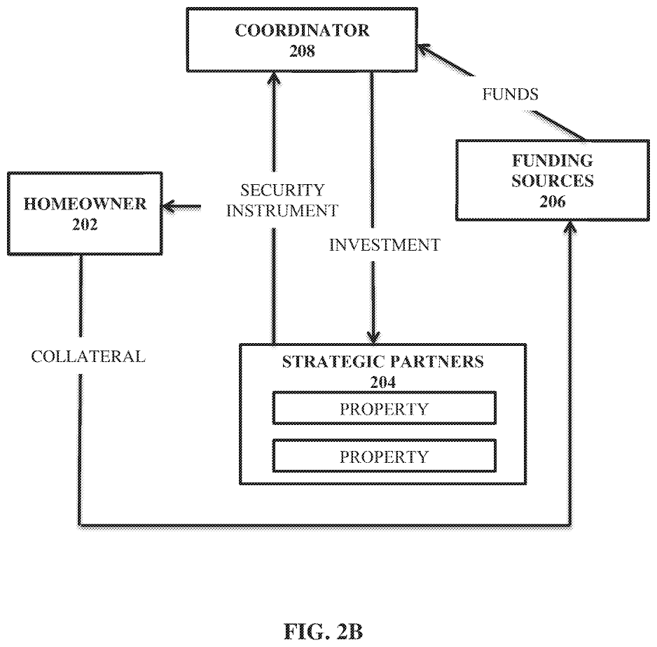

FIGS. 2A, 2B are simplified diagrams illustrating interaction of homeowner 202, strategic partners 204, funding sources 206 and coordinator 208 through a network 210. Servers 212 are shown through which transactions between the parties can be processed.

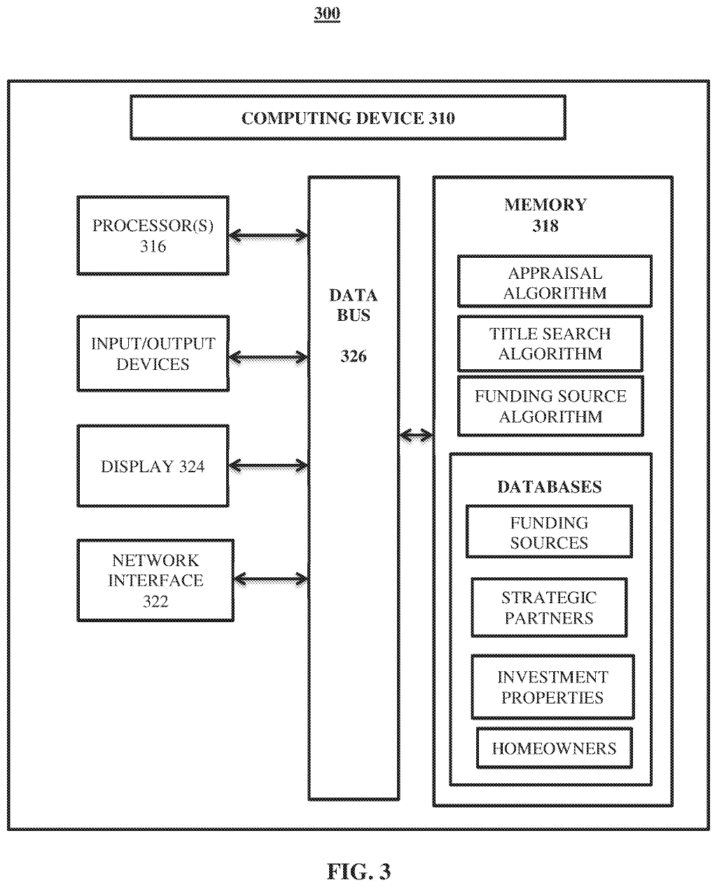

FIG. 3 depicts a simplified block diagram of an exemplary hardware environment 300 for the equity lease/swap platform, according to an illustrative embodiment of the disclosed method and system. The illustrative implementation platform 300 includes a computing device 310, which may be in communication with one or more other computing systems or devices 312 via one or more networks 314. Illustratively, a portion of the equity lease/swap platform is local to the computing device 310, while another portion may be distributed across one or more of the other computing systems or devices 312 that are connected to the network(s) 314. In some embodiments, portions of the platform 300 may be incorporated into other systems or interactive software applications. Such applications or systems may include, for example, operating systems, middleware or framework (e.g., application programming interface or API) software, and/or user-level applications software (e.g., a virtual personal assistant, another interactive software application or a user interface for a computing device).

The illustrative computing device 310 includes at least one processor 316 (e.g. a microprocessor, microcontroller, digital signal processor, etc.), memory 318, and an input/output (I/O) subsystem 320. Computing device 310 may be embodied as any type of computing device such as a personal computer (e.g., desktop, laptop, tablet, smart phone, body-mounted device, etc.), a server, an enterprise computer system, a network of computers, a combination of computers and other electronic devices, or other electronic devices. Although not specifically shown, it should be understood that the I/O subsystem 320 typically includes, among other things, an I/O controller, a memory controller, and one or more I/O ports. Processor 316 and I/O subsystem 320 are communicatively coupled to memory 318. Memory 318 may be embodied as any type of suitable computer memory device (e.g., volatile memory such as various forms of random access memory).

I/O subsystem 320 is communicatively coupled to a number of components including one or more user input devices 320 (e.g., a touchscreen, keyboard, virtual keypad, microphone, etc.), one or more storage media, one or more output devices 320 (e.g., speakers, LEDs, etc.), one or more displays 324 and one or more network interfaces 322, such as via data bus 326, for example. Memory 318 may include one or more hard drives or other suitable data storage devices (e.g., flash memory, memory cards, memory sticks, and/or others). In some embodiments, portions of the systems software (e.g., an operating system, etc.), framework/middleware (e.g., APIs, object libraries, etc.) may reside at least temporarily in memory 318. Portions of systems software, framework/middleware may be copied to memory 318 during operation of computing device 310, for faster processing or other reasons.

Memory 318 may include algorithms, which when executed carry out the methods disclosed herein. For example, memory 318 may include appraisal algorithm 332, title search algorithm 330 and funding source algorithm 332. Memory 318, which may be housed on a server or group of services or include databases 334 stored in the cloud, may include for example, a funding source database 336, strategic partner database 338, investment properties database 340 and homeowner database 342. Additional algorithms requiring information from any of the databases may also be stored in memory 318, which when executed carry out the one or more of the methods disclosed herein.

The one or more network interfaces 322 may communicatively couple computing device 310 to a local area network, wide area network, personal cloud, enterprise cloud, public cloud, and/or the Internet, for example. Accordingly, network interfaces 322 may include one or more wired or wireless network interface cards or adapters, for example, as may be needed pursuant to the specifications and/or design of the particular cross-sell platform. The other computing system(s) 312 may be embodied as any suitable type of computing system or device such as any of the aforementioned types of devices or other electronic devices or systems. For example, in some embodiments, the other computing systems 312 may include one or more server computers used to store portions of various databases. The platform 300 may include other components, sub-components, and devices not illustrated in FIG. 3 for clarity of the description. In general, the components of platform 300 are communicatively coupled as shown in FIG. 3 by electronic signal paths, which may be embodied as any type of wired or wireless signal paths capable of facilitating communication between the respective devices and components.

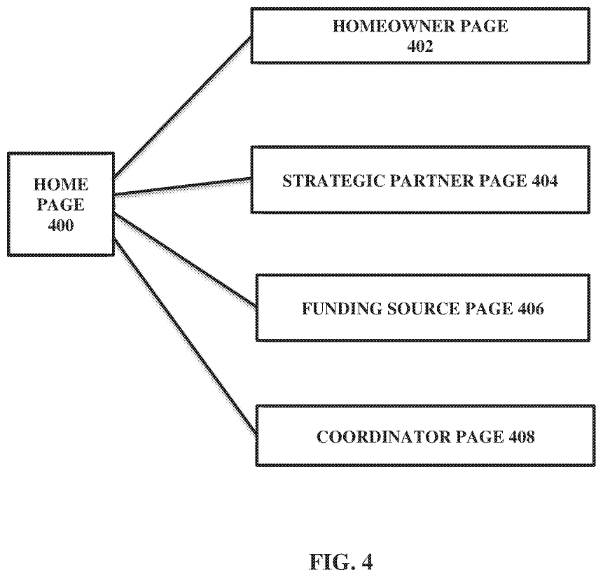

Illustrative webpages are shown in FIG. 4. A home page 400 is provided from which various parties to the method and transactions can access information and take actions. From home page 400, the following pages may be accessed, homeowner page 402, strategic partner page 404, funding source page 406 and coordinator page 408.

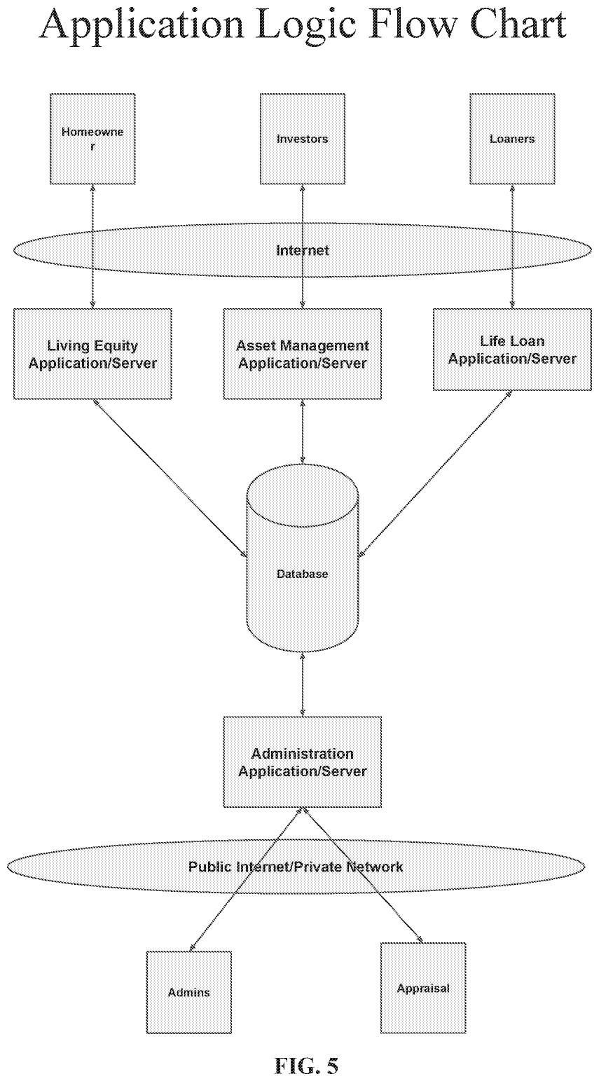

FIG. 5 is an application logic flow chart according to an illustrative embodiment. Additional aspects may be included in any combination in various illustrative embodiments. Investors' funds may be invested in different increments into different properties up to 100% of the property value or possibly greater than that amount. The basic concept and objective would be to spread each dollar invested over many properties so that in the unlikely scenario of a loss in any one property, the additional properties will make up part or all of the difference.

An algorithm may be used whereby potential investor funds can be identified and matched to the customers.

A component of the loan program may be implemented that allows for certain protection through reserves or insurance products, providing for monthly payment guarantee for the customers as an added benefit.

Membership-like products and/or services as a group benefit may be included for the customers.

The system may also play a role in matching the investors to the property in geographical boundaries set in each state the entity serves or operates in. Certain discounted services and/or products may be provided to the customers who are in a membership or other with the coordinator. As an example, the company may provide diverse insurance products (e.g. homeowner's insurance) that can enhance the business model.

An algorithm that determines future lending or lendability to customers based on customers' future needs may be incorporated into this model.

Federal Home Mortgage Loan Corporation/Federal National Mortgage Association (FHMLC/FNMAE) loan requirements/conditions may be used to fund other loan products that are marketed to its customer base and/or outside of that.

One or more of the method steps may be automated, such as identifying suitable homeowners, identifying investments to make suitable for particular homeowners, or groups of homeowners, or any other disclosed method steps. Databases necessary to draw from for the various method steps may be existing databases compiled by third parties or may be unique databases compiled created specifically for the equity lease/swap methods. For example, databases of real estate investment opportunities may exist from third parties or be compiled by the coordinator or a person or entity working on behalf of the coordinator, which may be accessed to carry out the steps of the equity lease/swap methods. Databases of homeowners and their corresponding equity in the real estate, or other lendability parameters that are weighed in determining whether a homeowner is suitable for the program may be utilized in the equity lease/swap methods. These too can be created for the purpose of the equity lease swap methods or be obtained from other sources.

Although certain embodiments have been described and illustrated in exemplary forms with a certain degree of particularity, it is noted that the description and illustrations have been made by way of example only. Numerous changes in the details of construction, combination of elements from various embodiments, and arrangement of parts and operations may be made. Additionally, the exclusion of elements may also create methods and systems within the intended scope of embodiments. Accordingly, such changes are intended to be included within the scope of the disclosure, the protected scope of which is defined by the claims.

1. A computer-implemented method for accessing equity in a property comprising:
identifying by a coordinator property owners having a threshold amount of equity in a property;
pledging by the property owner a portion of its equity to a coordinator as a lease/swap of equity;
arranging by the coordinator a loan and use the property owner's equity as security against a loan;
assigning the net proceeds of the loan to the coordinator, wherein the coordinator is the guarantor for loan/mortgage payment;
receiving by the coordinator the net proceeds;
applying by the coordinator the net proceeds to an investment via a strategic partner, wherein the strategic partner locates a suitable revenue-producing property or other asset as the investment;
delivering by the revenue-producing property a required return;
applying the return to pay the mortgage and a dividend to the property owner; and
identifying a security instrument and recording the security instrument with the property owner and the coordinator as co-beneficiaries.

2. A computer readable medium program to carry out the method of claim 1 or any other methods described herein.

3. A computer system comprising:
one or more processors;
memory coupled to the one or more processors on which is stored computer code, which when executed carries out the method of claim 1 or any other the method described herein.

4. A system for accessing equity in a property and providing an owner of the property with income, comprising:
a computing device, optionally in communication with one or more other computing systems or devices via one or more networks;
the computing device having at least one processor and memory;
the memory having one or more algorithms, selected from an appraisal algorithm, title search algorithm and funding source algorithm;
the computing device drawing from databases including one or more of a funding source database, a strategic partner database, an investment properties database and a homeowner database.

5. A financial product comprising:
an equity lease/swap arrangement according to claim 1 or any of the embodiments described herein.
